(19) United States
(12) Patent Application Publication
(10) Pub. No.: US 2023/0413735 A1
(43) Pub. Date: Dec. 28, 2023

(54) ELECTRIC SCISSORS AND CONTROL SYSTEM THEREOF

(71) Applicant: Cloudious9 Inc., Fremont, CA (US)

(72) Inventors: Richard Yao Tien Huang, Fremont, CA (US); Dominick Volpini, Hayward, CA (US)

(21) Appl. No.: 18/463,409

(22) Filed: Sep. 8, 2023

(30) Foreign Application Priority Data
Sep. 1, 2023 (CN) 202311121580.5

(51) Int. Cl. A01G 3/037

(52) U.S. Cl. CPC A01G 3/037

(57) ABSTRACT

A pair of electric scissors and a control system thereof are provided, which relate to the technical field of garden equipment. The electric scissors include a shell, a fixed blade, a movable blade, a drive mechanism, and an actuator; the fixed blade is arranged on the shell; the movable blade is rotatably connected to the fixed blade; the drive mechanism is arranged on the shell; the drive mechanism is connected to the movable blade; the drive mechanism is configured to cause the movable blade to rotate relative to the fixed blade; the movable blade and the fixed blade are connected to the drive mechanism in a plugging fit manner, so as to achieve detachable connection between the movable blade and the fixed blade; the actuator is connected to the drive mechanism. The present disclosure has an effect of replacing the fixed blade and the movable blade more easily.

### TECHNICAL FIELD

The present disclosure relates to the technical field of garden equipment, and more particularly, to a pair of electric scissors and a control system thereof.

### BACKGROUND

In a garden maintenance process, it is necessary to trim shrubs, trees, and other plants. Electric scissors are widely used in gardening pruning. For existing electric scissors, for example, China patent No. CN208924729U discloses an anti-overheating structure for electric garden scissors. The existing electric scissors have good heat absorption and insulation layers, which reduce heat transferred from a motor to a grip as much as possible. At the same time, an independent exhaust fan is used. The exhaust fan rotates independently. Therefore, compared to an exhaust fan connected to a motor shaft, this exhaust fan can reduce the work done by the motor and reduce a certain amount of heat generated by the motor.

Although the existing electric scissors can well dissipate heat, when the electric scissors are used to trim branches, a cutting edge of a blade may be worn in different extents. However, when the degree of wear on the cutting edge has a significant impact on next cutting, it may cause the blade to be unable to cut branches and leaves. In this case, a driving source in the electric scissors may be damaged. Therefore, it is necessary to replace the blade of the electric scissors. The blade is connected to a drive mechanism in the electric scissors through a screw, so it is more troublesome to replace the blade.

Therefore, in response to this situation, it is urgent to propose electric scissors and a control system thereof to overcome the shortcomings in current practical applications.

### SUMMARY

### (I) Technical Problems to be Solved

The present disclosure aims to solve the problem that it is more troublesome to replace the blade when a blade of existing electric scissors needs to be replaced.

### (II) Technical Solution

A pair of electric scissors and a control method thereof, provided according to the present disclosure, adopt the following technical solutions:

A pair of electric scissors and a control system thereof include a shell, a fixed blade, a movable blade, a drive mechanism, and an actuator; the fixed blade is arranged on the shell; the movable blade is rotatably connected to the fixed blade; the drive mechanism is arranged on the shell; the drive mechanism is connected to the movable blade; the drive mechanism is configured to cause the movable blade to rotate relative to the fixed blade, and the movable blade or the fixed blade is connected to the drive mechanism in a plugging fit manner to achieve detachable connection between the movable blade and the fixed blade; the actuator is mounted on the shell; and the actuator is connected to the drive mechanism.

By the adoption of the above technical solution, when the electric scissors are used to trim branches and leaves, if a cutting edge of the movable blade or the fixed blade is significantly worn, the fixed blade and the movable blade need to be replaced. Due to the pluggable connection of the fixed blade and the movable blade to the drive mechanism, the fixed blade and the movable blade are pulled out and removed, so that the replacement of the fixed blade and the movable blade can be completed. According to this design method, screw connection is not required during the replacement. This makes the replacement of the movable blade and the fixed blade more convenient. Moreover, only the fixed blade and movable blade are replaced, which can also reduce the cost of blade replacement.

Preferably, an accommodating cavity is arranged in the shell; the drive mechanism includes a rotating shaft, a rotating plate, and a bevel gear; the rotating shaft is arranged in the accommodating cavity; positions, far from cutting edges of the fixed blade and the movable blade, on the fixed blade and the movable blade sleeve the rotating shaft; the rotating plate rotatably sleeves the rotating shaft; one end of the rotating plate extends out of the accommodating cavity; the end, extending out of the accommodating cavity, of the rotating plate is provided with a limiting column; one end, far from the limiting column, of the rotating plate is provided with teeth; the bevel gear is in drive connection with the actuator; the bevel gear is engaged with the teeth of the rotating plate; the movable blade is provided with a limiting slot; and the limiting slot is configured to plug the limiting column to achieve detachable connection between the movable blade (3) and the rotating plate (43) through a cooperation between the limiting slot (31) and the limiting column (431).

By the adoption of the above technical solution, when the electric scissors are used, the actuator may start to work to rotate the bevel gear. Due to the engagement between the bevel gear and the teeth on the rotating plate, the rotating plate rotates along an axis of the rotating shaft. Due to the cooperation between the limiting column and the limiting slot, the movable blade is driven to rotate in a reciprocating manner relative to the fixed blade, thus achieving the function of the electric scissors for cutting the branches and leaves. When the fixed blade and the movable blade need to be replaced, only the movable blade and the fixed blade are pulled out from the rotating shaft. At this time, the limiting column and the limiting slot may be separated, and the replacement of the fixed blade and the movable blade can be achieved.

Preferably, the shell is provided with two limiting blocks at an opening of the accommodating cavity; the two limiting blocks are respectively arranged on two sides of the opening of the accommodating cavity; and the two limiting blocks are configured to limit the fixed blade.

By the adoption of the above technical solution, due to the arrangement of the limiting blocks, when the fixed blade and the movable blade are mounted on the rotating plate, one side, far from the cutting edge of the fixed blade, of the fixed blade may be located between the two limiting blocks, and the two limiting blocks will limit the rotation of the fixed blade, so that the fixed blade can be fixed on the rotating shaft. Thus, it is possible to avoid, as much as possible, a phenomenon of an offset of the fixed blade caused when the movable blade rotates under the action of the drive mechanism.

Preferably, a structural form of the actuator is a driving motor; the bevel gear is in drive connection with an output shaft of the driving motor; the drive mechanism further includes a connecting frame; the connecting frame is arranged in the accommodating cavity; the rotating shaft and the limiting blocks are arranged in the connecting frame; and the connecting frame is connected to the driving motor.

By the adoption of the above technical solution, due to the arrangement of the connecting frame, the driving motor can be connected to an inner wall of the accommodating cavity through the connecting frame. When the driving motor has an offset, the connecting frame can also move synchronously to ensure that the bevel gear is always engaged with the teeth on the rotating plate, so as not to affect the rotation of the movable blade relative to the fixed blade.

Preferably, the shell is provided with a knife case; the knife case and the shell can form a cavity; the knife case is provided with a through hole; the movable blade and the fixed blade penetrate through the through hole; a stopper is arranged on the knife case; when the knife case is mounted on the shell, the stopper can resist against one side surface, far from the movable blade, of the fixed blade; and the movable blade and the fixed blade are removed by only disconnecting the knife case from the shell, instead of using other tools to assist in the removal.

By the adoption of the above technical solution, due to the arrangement of the knife case, when the knife case is mounted on the shell, the stopper on the knife case can resist against the side, far from the movable blade, of the fixed blade. The stopper may stop the fixed blade, which can avoid the fixed blade and the movable blade from sliding on the rotating shaft as much as possible. Meanwhile, the portion, extending out of the accommodating cavity, of the rotating plate, the rotating shaft, and a rotating center of the movable blade are all arranged in the cavity formed between the knife case and the shell, which can prevent harmful substances such as dust from corroding the rotating plate, the movable blade, and the fixed blade.

Preferably, the shell is provided with a clamping hole; the clamping hole is communicated to the accommodating cavity; the knife case is provided with a clamping piece; the clamping piece resists against an inner wall of the accommodating cavity through the clamping hole; the clamping piece has an acting force approaching the inner wall of the accommodating cavity, and the knife case is provided with a release hole; a release block is arranged on one side surface, resisting against a side wall of the accommodating cavity, of the clamping piece; the release block passes through the release hole; and the release block is pressed by a person.

By the adoption of the above technical solution, due to the arrangement of the clamping piece and the clamping hole, when the knife case is mounted on the shell, the clamping piece may extend into the accommodating cavity through the clamping hole. At the same time, the clamping piece may have the acting force towards the inner wall of the accommodating cavity under the own action of the clamping piece, so that the clamping piece always has a predetermined acting force to resist against the accommodating cavity, and the knife case is mounted on the shell more stably. Meanwhile, due to the arrangement of the release hole and the release block, when the fixed blade and the movable blade need to be replaced, the release block is pressed to separate the clamping piece from the inner wall of the accommodating cavity, and then the knife case can be pulled out, so that the fixed blade and the movable blade can be replaced.

Preferably, an illuminating lamp is arranged on one side, close to the movable blade, of the shell.

By the adoption of the above technical solution, due to the arrangement of the illuminating lamp, when branches and leaves are cut in a relatively dark environment, the illuminating lamp can serve as a light source, making it easier for a user to see things more clearly, thereby facilitating the user to cut the branches and the leaves.

Preferably, a control module is arranged in the accommodating cavity; the control module is electrically connected to the driving motor; the control module is configured to control a speed of the driving motor; a button is arranged on the shell; the button is electrically connected to the control module; and the button is configured to change a maximum opening and closing angle between the movable blade and the fixed blade.

By the adoption of the above technical solution, the button is pressed, so that the control module sends a command to the driving motor to change the speed of the output shaft of the driving motor. Therefore, the number of rotations of a screw rod may change within the same time, which can change a sliding distance of a nut on the screw rod, thereby changing the maximum angle between the movable blade and the fixed blade during rotation. Furthermore, the maximum opening and closing angle between the movable blade and the fixed blade on the electric scissors can be adjusted.

The present disclosure further provides a control system of electric scissors, including the above electric scissors.

In conclusion, the present disclosure includes at least one of the following beneficial technical effects:
1. When the electric scissors are used to trim branches and leaves, if a cutting edge of the movable blade or the fixed blade is significantly worn, the fixed blade and the movable blade need to be replaced. Due to the pluggable connection of the fixed blade and the movable blade to the drive mechanism, the fixed blade and the movable blade are pulled out and removed, so that the replacement of the fixed blade and the movable blade can be completed. According to this design method, screw connection is not required during the replacement. This makes the replacement of the movable blade and the fixed blade more convenient. Moreover, only the fixed blade and movable blade are replaced, which can also reduce the cost of blade replacement.
2. Due to the arrangement of the clamping piece and the clamping hole, when the knife case is mounted on the shell, the clamping piece may extend into the accommodating cavity through the clamping hole. At the same time, the clamping piece may have the acting force towards the inner wall of the accommodating cavity under the own action of the clamping piece, so that the clamping piece always has a predetermined acting force to resist against the accommodating cavity, and the knife case is mounted on the shell more stably. Meanwhile, due to the arrangement of the release hole and the release block, when the fixed blade and the movable blade need to be replaced, the release block is pressed to separate the clamping piece from the inner wall of the accommodating cavity, and then the knife case can be pulled out, so that the fixed blade and the movable blade can be replaced.
3. Due to the arrangement of the control module and the button, when the maximum opening and closing angle of the movable blade relative to the fixed blade needs to be replaced, the button is pressed, so that the control module sends a command to the driving motor to change the speed of the output shaft of the driving motor. Therefore, the number of rotations of a screw rod may change within the same time, which can change a sliding distance of a nut on the screw rod, thereby changing the maximum angle between the movable blade and the fixed blade during rotation. Furthermore, the maximum opening and closing angle between the movable blade and the fixed blade on the electric scissors can be adjusted.

### BRIEF DESCRIPTION OF THE DRAWINGS

FIG. 1 is an overall schematic diagram of a pair of electric scissors in an embodiment of the present disclosure.

FIG. 2 is a schematic diagram showing a structure of an inner wall of an accommodating cavity in an embodiment of the present disclosure.

FIG. 3 is a schematic structural diagram of a drive mechanism and an actuator in an embodiment of the present disclosure.

FIG. 4 is a schematic diagram a movable blade in an embodiment of the present disclosure.

FIG. 5 is a schematic diagram of a fixed blade in an embodiment of the present disclosure.

FIG. 6 is a schematic diagram showing a knife case and a structure of the knife case in an embodiment of the present disclosure.

Reference numerals in the drawings: 1: shell; 11: accommodating cavity; 12: clamping hole; 13: clamping block; 2: fixed blade; 3: movable blade; 31: limiting slot; 4: drive mechanism; 41: connecting frame; 411: limiting block; 42: rotating shaft; 43: rotating plate; 431: limiting column; 44: bevel gear; 5: actuator; 51: driving motor; 6: knife case; 61: stopper; 62: clamping piece; 621: release block; 622: clamping block hole; 63: release hole; and 7: illuminating lamp.

### DETAILED DESCRIPTION OF THE EMBODIMENTS

The present disclosure is further described in detail below in combination with accompanying drawings 1-6.

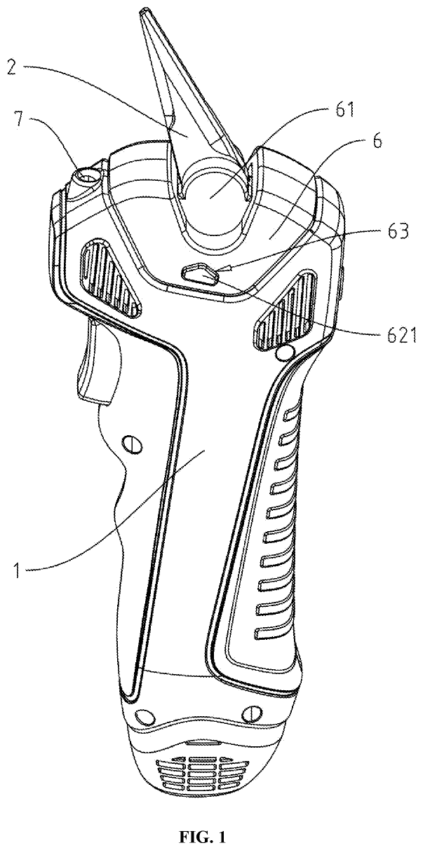

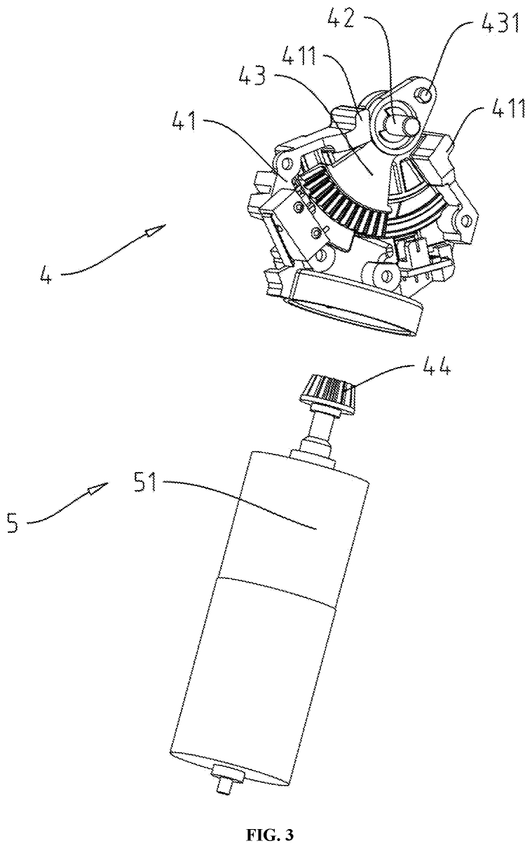

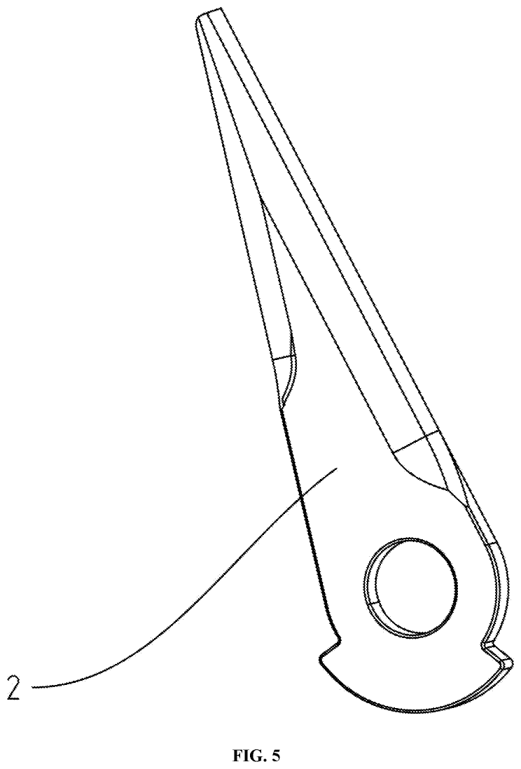

An embodiment of the present disclosure discloses a pair of electric scissors. Referring to FIG. 1 to FIG. 5, the electric scissors include a shell 1, a fixed blade 2, a movable blade 3, a drive mechanism 4, and an actuator 5. Specifically, the fixed blade 1 includes an upper shell and a lower shell. The upper shell and the lower shell have thin walls. The upper shell and the lower shell are mounted together through a screw to form an accommodating cavity 11. The accommodating cavity 11 is provided with an opening in one side of the shell 1. The fixed blade 2 is arranged at the opening of the shell 1. The movable blade 3 is rotatably connected to the fixed blade 2. Cutting edges are arranged on sides, far from a rotating center, of the movable blade 3 and the fixed blade 2. The cutting edges of the movable blade 3 and the fixed blade 2 are arranged near each other. A cutting function of the electric scissors is achieved by the reciprocating rotation of the movable blade 3 relative to the fixed blade 2. The drive mechanism 4 is arranged in the accommodating cavity 11. The drive mechanism 4 and the movable blade 3 are connected in a plugging manner, so as to drive the movable blade 3 to rotate. The actuator 5 is arranged in the accommodating cavity 11. The actuator 5 is in drive connection to the drive mechanism 4, so that when the actuator 5 starts to work, the drive mechanism 4 may drive the movable blade 3 to rotate under the action of the actuator 5, so as to achieve the cutting function of the electric scissors. After the electric scissors are used to cut branches and leaves for a period of time, the cutting edges of the fixed blade 2 and the movable blade 3 may be worn to different extents, which may cause the blades to be unable to cut the branches and leaves. Therefore, the fixed blade 2 and the movable blade 3 need to be replaced. Due to plugging fit between the movable blade 3 and the drive mechanism 4, only the fixed blade 2 and the movable blade 3 need to be pulled out and removed to complete the replacement of the fixed blade 2 and the movable blade 3, thereby making the replacement of the movable blade 3 and the fixed blade 2 easier. Meanwhile, only the fixed blade 2 and the movable blade 3 are replaced, which can also reduce the cost of blade replacement.

Referring to FIG. 1 to FIG. 3, the drive mechanism 4 includes a connecting frame 41, a rotating shaft 42, a rotating plate 43, and a bevel gear 44. Specifically, the connecting frame 41 is arranged in the accommodating cavity 11. The connecting frame 41 is arranged on one side, close to the opening, of the accommodating cavity 11. The connecting frame 41 may extend out of the accommodating cavity 11. The rotating shaft 42 is in the shape of a cylindrical rod. The rotating shaft 42 is integrally arranged on the connecting frame 41, and the rotating shaft 42 is arranged on a portion, extending out of the accommodating cavity 11, of the connecting frame 41. Both of the fixed blade 2 and the movable blade 3 sleeve the rotating shaft 42. The rotating plate 43 rotatably sleeves the rotating shaft 42, and a rotating centerline of the rotating plate 43 and rotating centerlines of the fixed blade 2 and the movable blade 3 are coaxial and represent an axis of the rotating shaft 42. One side surface of the rotating plate 43 may resist against the connecting frame 41, and the other side surface resists against the movable blade 3. One side of the rotating plate 43 may be located in the accommodating cavity 11. One side, outside the accommodating cavity 11, of the rotating plate 43 is provided with a limiting column 431. The limiting column 431 is in the shape of a cylindrical rod. The limiting column 431 is integrally arranged on the rotating plate 43. Meanwhile, a limiting slot 31 is formed in one side surface, close to the rotating plate 43, of the movable blade 3. The limiting slot 31 has a round cross section from a notch. The limiting slot 31 is matched with the limiting column 431 to plug the limiting column 431. When the rotating plate 43 rotates, the movable blade 3 can rotate with the rotating plate 43. The side, located in the accommodating cavity 11, of the rotating plate 43 is provided with teeth. Furthermore, a structural form of the teeth on the rotating plate 43 is the same as a structural form of teeth on a face gear. The bevel gear 44 is rotatably connected into the accommodating cavity 11. The bevel gear 44 is in drive connection with the actuator 5. The bevel gear 44 is engaged with the teeth on the rotating plate 43. Therefore, when the actuator 5 works, the bevel gear 44 may rotate. The bevel gear 44 drives the rotating plate 43 to rotate, so that the movable blade 3 rotates relative to the fixed blade 2. When the movable blade 3 and the fixed blade 2 need to be replaced, only the movable blade 3 needs to be unplugged from the rotating plate 43, so that the limiting column 431 is separated from the limiting slot 31 for replacement.

Meanwhile, two limiting blocks 411 are arranged on the connecting frame 41. The two limiting blocks 411 are arranged at the opening of the accommodating cavity 11. When the fixed blade 2 sleeves the rotating shaft 42, one side, far from the cutting edge of the fixed blade, of the fixed blade 2 may be located between the two limiting blocks 411, so that when the drive mechanism 4 drives the movable blade 3 to rotate, the side, far from the cutting edge of the fixed blade, of the fixed blade 2 may be fixed under the action of the two limiting blocks 411, and the fixed blade 2 may not have an offset in the rotation. Thus, it will not affect the cutting effect of the electric scissors.

In addition, in this embodiment, a structural form of the actuator 5 is a driving motor 51. An output shaft of the driving motor 51 is coaxially and fixedly connected to the bevel gear 44 to drive the rotation plate 43 to rotate. In other embodiments, the rotation of the bevel gear 44 can be achieved through other forms. The driving motor 51 is connected to the connecting frame 41 through a bolt, which can keep the rotating plate 43 at a relative position with the driving motor 51, to ensure that the bevel gear 44 is always engaged with the teeth on the rotating plate 43, so as not to affect the rotation of the movable blade 3 relative to the fixed blade 2.

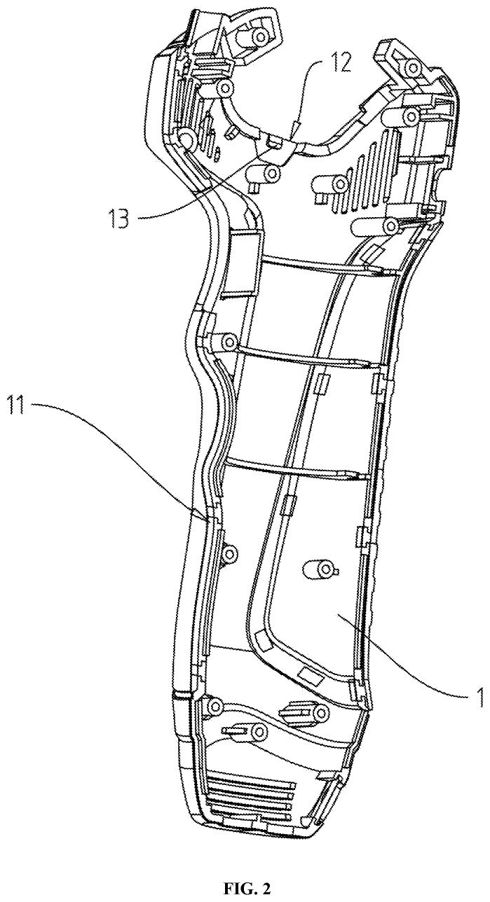

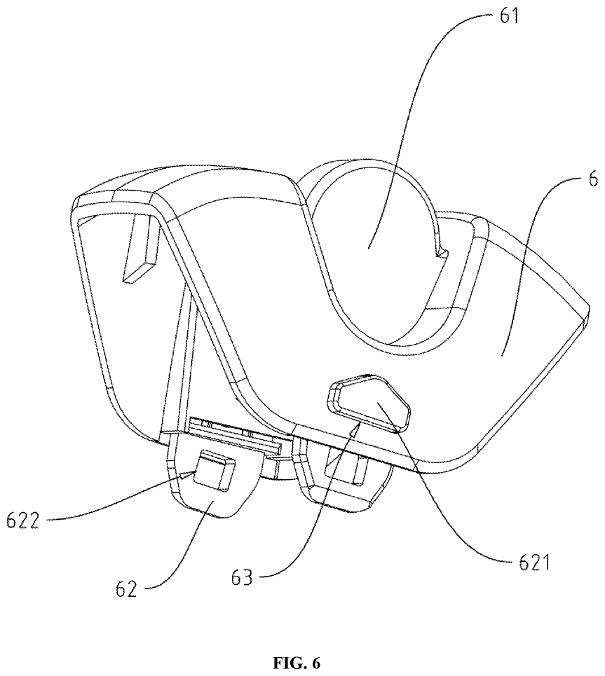

Referring to FIG. 2 to FIG. 6, a knife case 6 is arranged at a position, close to the opening of the accommodating cavity 11, on the shell 1. A cross section of the knife case 6 will be U-shaped, and a through hole is formed in a U-shaped inner side of the knife case 6 for the fixed blade 2 and the movable blade 3 to pass through. Moreover, when the knife case 6 is mounted on the shell 1, an inner side wall of the knife case 6 and an outer side wall of the shell 1 form a cavity; two clamping holes 12 are formed in joints of the shell 1 and the knife case 6; the clamping holes 12 are communicated to the accommodating cavity 11; one side wall of each of the clamping holes 12 is in the same plane as a side wall of the accommodating cavity 11 at the position. The two clamping holes 12 are respectively formed in the upper shell and the lower shell, and the two clamping holes 12 are arranged at opposite positions. Clamping pieces 62 are arranged on two inner sides of the U shape of the knife case 6; the two clamping pieces 62 have acting forces that are far away from each other. When the knife case 6 is mounted on the shell 1, one side, far from a bent inner side of the knife case 6, of each of the clamping pieces 62 may pass through the corresponding clamping hole 12 and enter the accommodating cavity 11; sides, far from each other, of the two clamping pieces 62 may have predetermined acting forces to resist against the side walls of the accommodating cavity 11, so that the knife case 6 can be stably mounted on the shell 1. Furthermore, release holes 63 are arranged on two opposite sides of the knife case 6, and one side surface, resisting against the accommodating cavity 11, of each of the clamping pieces 62 is integrally provided with a release block 621. The release blocks 621 are arranged in the release holes 63 in a penetrating manner under the action of a clamping plate. When it is necessary to remove the knife case 6 and replace the fixed blade 2 and the movable blade 3, only the two release blocks 621 need to be pressed to make the clamping pieces 62 no longer resist against the inner wall of the accommodating cavity 11, and the knife case 6 can be easily removed.

Referring to FIG. 2 to FIG. 6, in order to further improve the stability of mounting the knife case 6 on the shell 1, a clamping block 13 is arranged on the accommodating cavity 11. The clamping block 13 is arranged on the side surface, resisting against the clamping piece 62, of the inner wall of the accommodating cavity 11, and the clamping block 13 is located on the side close to the opening of the accommodating cavity 11. A clamping block hole 622 is formed in each clamping piece 62. The clamping block hole 622 is configured to plug the clamping block 13. When the knife case 6 is mounted on the shell 1, a side walls of the clamping block 13 may block the clamping pieces 62, which further improves the stability of mounting the knife case 6.

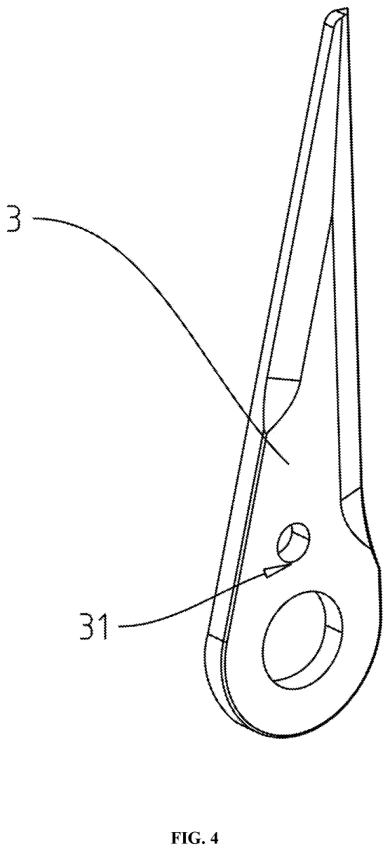

Referring to FIG. 4 to FIG. 6, the knife case 6 is provided with a stopper 61 at the through hole. When the knife case 6 is mounted on the shell 1, the stopper 61 may resist against one side surface, far from the movable blade 3, of the fixed blade 2, which can avoid the fixed blade 2 from moving in an axial direction of the rotating shaft 42 as much as possible.

Referring to FIG. 1, an illuminating lamp 7 is arranged on one side, close to the fixed blade 2, of the shell 1. Therefore, when the electric scissors are used in a relatively dark environment, the illuminating lamp 7 can be used as a light source to make a user see things more clearly, making it easier for the user to cut branches and leaves.

In addition, in this embodiment, a control module and a button are arranged on the shell 1. The control module is arranged in the shell 1. In this embodiment, the control module is a micro control unit (MCU) chip and is electrically connected to the driving motor 51 to control a speed of the output shaft of the driving motor 51. The button is arranged on one side edge of the shell 1 and is used by a user. The button is electrically connected to the MCU chip. When the user presses the button, the button may send a signal to the MCU chip, and the MCU chip may send an electrical signal to the driving motor 51 to change the speed of the output shaft of the driving motor 51, so a speed of the bevel gear 44 may also change. Therefore, a rotation angle of the movable blade 3 may be changed under the cooperation of the bevel gear 44 and the rotating plate 43, and the maximum opening and closing angle between the movable blade 3 and the fixed blade 2 on the electric scissors can be adjusted.

The present disclosure further provides a control system of electric scissors, including the above electric scissors.

The implementation principles of the electric scissors and the control system thereof in the embodiments of the present disclosure are as follows: The driving motor 51 is started to drive the bevel gear 44 to rotate. Due to the engagement between the bevel gear 44 and the teeth on the rotating plate 43, the rotating plate 43 rotates to drive the movable blade 3 to rotate relative to the fixed blade 2, thereby achieving the cutting function of the electric scissors. When the fixed blade 2 or the movable blade 3 is significantly worn, the release blocks 621 are pressed to separate the clamping pieces 62 from the inner walls of the accommodating cavity 11, and the clamping block 13 may be separated from the clamping block holes 622. In this case, the knife case 6 can be removed from the shell 1. Therefore, the stopper 61 may not restrain the fixed blade 2. Due to the plugging fit between the movable blade 3 and the rotating plate 43, the fixed blade 2 and the movable blade 3 can be removed from the rotating shaft 42, so that the fixed blade 2 and the movable bade 3 can be replaced after being removed without using other auxiliary tools making the replacement of the movable blade 3 and the fixed blade 2 easier. At the same time, only the fixed blade 2 and the movable blade 3 are replaced, which can also reduce the cost of blade replacement.

The preferred embodiments of the present disclosure are described above, and are not intended to limit the protection scope of the present disclosure. Therefore, any equivalent changes made according to the structure, shape and principle of the present disclosure shall all fall within the protection scope of the present disclosure.

What is claimed is:

1. A pair of electric scissors, comprising a shell (1), a fixed blade (2), a movable blade (3), a drive mechanism (4), and an actuator (5), wherein the fixed blade (2) is arranged on the shell (1); the movable blade (3) is rotatably connected to the fixed blade (2); the drive mechanism (4) is arranged on the shell (1); the drive mechanism (4) is connected to the movable blade (3); the drive mechanism (4) is configured to cause the movable blade (3) to rotate relative to the fixed blade (2), and the movable blade (3) or the fixed blade (2) is connected to the drive mechanism (4) in a plugging fit manner to achieve detachable connection between the movable blade (3) and the fixed blade (2); the actuator (5) is mounted on the shell (1); and the actuator (5) is connected to the drive mechanism (4).

2. The electric scissors according to claim 1, wherein an accommodating cavity (11) is arranged in the shell (1); the drive mechanism (4) comprises a rotating shaft (42), a rotating plate (43), and a bevel gear (44); the rotating shaft (42) is arranged in the accommodating cavity (11); positions, far from cutting edges of the fixed blade and the movable blade, on the fixed blade (2) and the movable blade (3) sleeve the rotating shaft (42); the rotating plate (43) rotatably sleeves the rotating shaft (42); one end of the rotating plate (43) extends out of the accommodating cavity (11); the end, extending out of the accommodating cavity (11), of the rotating plate (43) is provided with a limiting column (431); one end, far from the limiting column (431), of the rotating plate (43) is provided with teeth; the bevel gear (44) is in drive connection with the actuator (5); the bevel gear (44) is engaged with the teeth of the rotating plate (43); the movable blade (3) is provided with a limiting slot (31); and the limiting slot (31) is configured to plug the limiting column (431) to achieve detachable connection between the movable blade (3) and the rotating plate (43) through a cooperation between the limiting slot (31) and the limiting column (431).

3. The electric scissors according to claim 2, wherein the shell (1) is provided with two limiting blocks (411) at an opening of the accommodating cavity (11); the two limiting blocks (411) are respectively arranged on two sides of the opening of the accommodating cavity (11); and the two limiting blocks (411) are configured to limit the fixed blade (2).

4. The electric scissors according to claim 3, wherein a structural form of the actuator (5) is a driving motor (51); the bevel gear (44) is in drive connection with an output shaft of the driving motor (51); the drive mechanism (4) further comprises a connecting frame (41); the connecting frame (41) is arranged in the accommodating cavity (11); the rotating shaft (42) and the limiting blocks (411) are arranged in the connecting frame (41); and the connecting frame (41) is connected to the driving motor (51).

5. The electric scissors according to claim 3, wherein the shell (1) is provided with a knife case (6); the knife case (6) and the shell (1) form a cavity; the knife case (6) is provided with a through hole; the movable blade (3) and the fixed blade (2) penetrate through the through hole; a stopper (61) is arranged on the knife case (6); when the knife case (6) is mounted on the shell (1), the stopper (61) resists against one side surface, far from the movable blade (3), of the fixed blade (2); the movable blade (3) and the fixed blade (2) are removed by only disconnecting the knife case (6) from the shell (1), instead of using other tools to assist in the removal.

6. The electric scissors according to claim 5, wherein the shell (1) is provided with a clamping hole (12); the clamping hole (12) is communicated to the accommodating cavity (11); the knife case (6) is provided with a clamping piece (62); the clamping piece (62) resists against an inner wall of the accommodating cavity (11) through the clamping hole (12); the clamping piece (62) has an acting force approaching the inner wall of the accommodating cavity (11), and the knife case (6) is provided with a release hole (63); a release block (621) is arranged on one side surface, resisting against a side wall of the accommodating cavity (11), of the clamping piece (62); the release block (621) passes through the release hole (63); and the release block (621) is pressed by a person.

7. The electric scissors according to claim 1, wherein an illuminating lamp (7) is arranged on one side, close to the movable blade (3), of the shell (1).

8. The electric scissors according to claim 4, wherein a control module is arranged in the accommodating cavity (11); the control module is electrically connected to the driving motor (51); the control module is configured to control a speed of the driving motor (51); a button is arranged on the shell (1); the button is electrically connected to the control module; and the button is configured to change a maximum opening and closing angle between the movable blade (3) and the fixed blade (2).

9. A control system of electric scissors, comprising the electric scissors according to claim 1.
